(19) United States
(12) Patent Application Publication
(10) Pub. No.: US 2006/0287406 A1
(43) Pub. Date: Dec. 21, 2006

(54) FOAMED COMPOUND FOR MEDICAL ARTICLES

(75) Inventors: Tsung-Hung Tsai, Chiayi City (TW); Chin-Fang Chang, Tai Ping City (TW)

Correspondence Address: NIKOLAI & MERSEREAU, P.A., 900 SECOND AVENUE SOUTH, SUITE 820, MINNEAPOLIS, MN, 55402, US

(73) Assignee: CHIN CHEN FUH ENTERPRISE CORP., Tai Ping City (TW)

(21) Appl. No.: 11/160,305

(22) Filed: Jun. 17, 2005

(51) Int. Cl. C08J 9/00

(52) U.S. Cl. 521/50

(57) ABSTRACT

A foamed compound for medical articles has ingredients including ethylene vinyl acetate, filler, co-agent, crosslinking agent, blowing agent, and pigment. Wherein ethylene vinyl acetate, the filler, the co-agent, the crosslinking agent, the blowing agent, and the pigment are mixed together in a proper proportion and then foamed. By using foregoing ingredients to manufacture the high density foamed compound, the foamed compound causes no allergic response on the skin and can be applicable to medical articles. Moreover, the foamed compound is non-toxic and can be recycled without causing any pollution.

### BACKGROUND OF THE INVENTION

1. Field of the Invention

The present invention relates to a foamed compound for medical articles, and more particularly to a foamed compound that is non-allergic and preferably applicable for medical articles such as seat pad, handle sleeves and some plastic surfaces contacting with skin.

2. Description of Related Art

Conventionally, medical articles or equipments (for example: walking crutches, walking frames, and wheelchairs etc.) have some resilient plastic pieces mounted on operational parts to serves as cushions to avoid users directly contact rigid structures of the medical articles or equipments. Thereby, the users feel comfortable when operates the medical articles or equipment by holding the operational parts. Moreover, the plastic pieces also provide anti-slipping efficiency. Conventional material for manufacturing the plastic pieces is substantially made of latex that contains heavy metals such as lead and cadmium and causes latex sequela such as irritant contact dermatitis, allergic contact dermatitis or immediate hypersensitivity. Therefore, the users contacting latex for a period of time will suffer for the latex sequela. Additionally, the plastic pieces made of latex are toxic and can not be recycled or decomposed because the heavy metals cause pollution after burning.

### SUMMARY OF THE INVENTION

To overcome the drawbacks of the conventional latex plastic pieces on the medical articles, a foamed compound is provided to eliminate the drawbacks.

The main objective of the present invention is to provide a foamed compound that is non-allergic to human skin and environmentally friendly.

To achieve the foregoing objective, the foamed compound for medical articles in the present invention has composition comprising:

ethylene vinyl acetate (EVA, containing 21 w/w % vinyl acetate): 21 PHR (parts per hundred of resin by weight, followings are the same);

filler: 10 PHR;

co-agent: 2 PHR;

crosslinking agent: 1 PHR;

blowing agent: 3 PHR; and

pigment: 0.6 PHR.

By using foregoing ingredients to manufacture the high density foamed compound, the foamed compound causes no allergic response on the skin and can be applicable to medical articles. Moreover, the foamed compound is non-toxic and can be recycled without causing any pollution.

Further benefits and advantages of the present invention will become apparent after a careful reading of the detailed description with appropriate reference to the accompanying drawings.

### BRIEF DESCRIPTION OF THE DRAWINGS

FIG. 1 is an operational side view of a walking crutch with a partial cross-section, wherein the walking crutch has a pad and a sleeve made of a foamed compound in accordance with the present invention;

FIG. 2 is a cross-sectional side view of the pad in FIG. 1;

FIG. 3 is a perspective view of the pad in FIG. 1; and

FIG. 4 is a perspective view of the sleeve made of the foamed compound in FIG. 1.

### DETAILED DESCRIPTION OF THE PREFERRED EMBODIMENT

A foamed compound for medical articles in accordance with the present invention has composition comprising:

ethylene vinyl acetate (EVA, containing 21 w/w % of vinyl acetate): 21 PHR (parts per hundred of resin by weight);

filler: 10 PHR;

co-agent: 2 PHR;

crosslinking agent: 1 PHR;

blowing agent: 3 PHR; and

pigment: 0.6 PHR.

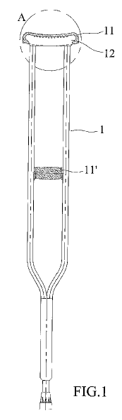

After foaming, the foamed compound is obtained and shaped into any desired shapes of plastic pieces such as an elongated pad 11 and a sleeve 11′ shown in FIG. 1. Unlike latex, ethylene vinyl acetate (EVA) resin causes no allergic response on human skin so that users have no sequela after contacting with the plastic pieces constantly. Moreover, the foamed compound contains no heavy metals, is non-toxic, recyclable and friendly to environment. Therefore, the foamed compound is suitable for manufacturing resilient plastic pieces for medical articles.

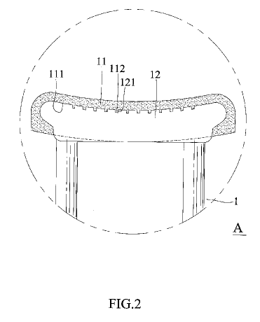

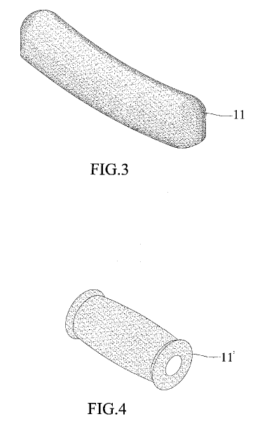

With particular reference to FIGS. 2 and 3, a preferred embodiment of the resilient plastic pieces is the elongated pad 111 mounted on a walking crutch 1. The elongated pad 11 has a bottom face and a cavity 111 defined in the bottom face so that a top bracket 12 of the walking crutch 1 is snugly received inside the cavity 111. To keep the elongated pad 11 in position, the elongated pad 11 has multiple positioning blocks 112 formed on an inner surface of the cavity 111 and the top bracket 12 of the walking crutch 1 further has multiple dentents 121 defined on the top bracket 12 to correspondingly engage the positioning blocks 112. Because the elongated pad 11 is resilient, size of cavity 111 in the elongated pad 11 is preferably slightly smaller than one of the top bracket 12 on the walking crutch 1 so that the elongated pad 11 can snugly constrict and mount on the top bracket 12. Moreover, the positioning blocks 112 of the elongated pad 11 and the detents 121 on the top bracket 12 also provide a positioning efficiency to avoid the elongated pad 11 from sliding.

With particular reference to FIGS. 1 and 4, another preferred embodiment of the resilient plastic pieces is the sleeve 11′ mounted on a transversal rod at a middle section of the walking crutch 1. When a user holds the walking crutch 1, the armpit rests on the bracket 12 and the corresponding palm grip at the transversal rod at the same time to support the user to stand or to walk. Therefore, the elongated pad 11 and the sleeve 11 respectively contact with the armpit and the palm and do not cause any allergic reaction.

According to above description, the foamed compound of the present invention has the following advantages:

1. The high density foamed compound of the present invention is mainly made of EVA that causes no allergic response on human skin so that the foamed compound is particularly suitable for applications on medical traction and exerciser such as walking crutches, walking frames, wheelchairs etc. Moreover, the foamed compound contains no heavy metal, is non-toxic and recyclable.

2. The present invention originally discloses that the EVA foamed compound used as resilient plastic pieces for medical articles or equipments to provide an excellent solution to substitute the latex of the conventional material.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A foamed compound for medical articles comprising ingredients of:
ethylene vinyl acetate;
filler;
co-agent;
crosslinking agent;
blowing agent; and
pigment;
wherein ethylene vinyl acetate, the filler, the co-agent, the crosslinking agent, the blowing agent, and the pigment are mixed together and then foamed to achieve the foamed compound.

2. The foamed compound as claimed in claim 1, wherein portions of the ingredients are:
ethylene vinyl acetate: 21 PHR;
filler: 10 PHR;
co-agent: 2 PHR;
crosslinking agent: 1 PHR;
blowing agent: 3 PHR; and
pigment: 0.6 PHR.

3. A resilient plastic piece for medical article, the resilient plastic piece is made of a foamed compound comprising ingredients of:
ethylene vinyl acetate;
filler;
co-agent;
crosslinking agent;
blowing agent; and
pigment;
wherein ethylene vinyl acetate, the filler, the co-agent, the crosslinking agent, the blowing agent, and the pigment are mixed together and then foamed and shaped into the resilient plastic piece.

4. The resilient plastic piece as claimed in claim 3, wherein the resilient plastic piece is an elongated pad 11 adapted to mount on a walking crutch 1 and comprising:
a bottom face;
a cavity 111 defined in the bottom face and having an inner surface; and
multiple positioning blocks 112 formed on the inner surface of the cavity 111.

5. The resilient plastic piece as claimed in claim 3, wherein the resilient plastic piece is a sleeve 11′ adapted to attach to a transversal rod on a walking crutch 1.
